(19) United States
(12) Patent Application Publication
(10) Pub. No.: US 2026/0108975 A1
(43) Pub. Date: Apr. 23, 2026

(54) Manufacturing large scale metal laminated object parts

(71) Applicant: Alloy Enterprises Inc., Burlington, MA (US)

(72) Inventors: William Johnson, Gloucester, MA (US); Paul Titchener, Somerville, MA (US); Lyle Cheatham, Marblehead, MA (US); Alan Lai, Cambridge, MA (US); Sean Geier, Cambridge, MA (US); Ellen Benn, Boston, MA (US); Kevin Simon, Somerville, MA (US); Nicholas Mykulowycz, Boxford, MA (US)

(21) Appl. No.: 19/121,786

(22) PCT Filed: Oct. 19, 2023
(86) PCT No.: PCT/US2023/077341

§ 371 Date: Apr. 16, 2025

Related U.S. Application Data
(60) Provisional application No. 63/380,226, filed on Oct. 19, 2022.

(51) Int. Cl. B23K 20/02

(52) U.S. Cl. CPC B23K 20/023

(57) ABSTRACT

Methods and apparatus for the manufacture of laminated metal parts having external dimensions exceeding 0.5 m in length, 0.5 m in width, and 0.1 m in height. Some embodiments include methods to apply force evenly to a workpiece via multiple rams and feature stiffened platens comprised of multiple alloys. Some embodiments include modifications to the workpiece itself, including designs for a temporary vacuum or controlled gas chamber constructed around the workpiece. Some embodiments include modifications to the workpiece and the support structures surrounding the part which direct force during bonding to the part. Control systems may be employed to coordinate the operation of the cylinders with heating, cooling, and pumping operations. Finally, some embodiments include alternative heating systems such as induction or joule heating.

### CROSS-REFERENCE TO RELATED APPLICATIONS

The present application claims the benefit of and priority to U.S. provisional application no. 63/380,226, filed on Oct. 19, 2022, the entire disclosure of which is hereby incorporated by reference as if set forth in its entirety herein.

### TECHNICAL FIELD

Embodiments described herein generally relate to methods and apparatus for fabricating large scale metal laminated object parts, and more specifically to the fabrication of large-scale parts surrounded by a support structure from an arbitrary number of metal sheets.

### BACKGROUND

Prior approaches to the laminated object manufacturing (LOM) of metal parts have largely focused on the production of small-scale components, often with a print bed sized less than 0.5 m². This focus on smaller components stems from the relative ease of maintaining precision and quality in smaller print spaces as compared to their larger counterparts.

With larger print bed sizes and build volumes, issues arise in scaling LOM processes. Part warping and deformation proportionally increase so that manufactured parts may be out of tolerance. Maintaining thermal uniformity across large workpieces for uniform bonding simultaneously across dozens to hundreds of layers may require multiple heating units and controls to distribute heat effectively. Atmospheric control, including purging oxygen or other oxidants during the bonding process, is an additional challenge. The application of uniform stress on workpieces with irregular or complex internal structures is a similar challenge. Finally, the transition to larger-scale manufacturing may require significant investments in infrastructure, including larger vacuum chambers and single-ram hydraulic presses whose cost increases linearly or super-linearly with print bed size.

Accordingly, scaling laminated object manufacturing to produce large, complex parts requires improvement to existing methods and apparatus to offer a viable manufacturing solution.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to methods for the manufacture of large-scale metal laminated object parts. The method includes assembling a plurality of metal sheets in a stack, each metal sheet having a thickness between 100 μm and 10 cm and an object portion and a support portion; removing a support portion from the stack; applying force to the stack via a moving ram plate driven by at least one ram to bond the object portions of the stack, wherein the bonded object portions of the stack form an object having external dimensions exceeding 0.5 m in length, 0.5 m in width, and 0.1 m in height.

In some embodiments the moving ram plate comprises multiple segments, each adjacent pair of segments connected by a flexure, with each segment attached to a separate ram.

In some embodiments the method further includes applying side plates to the stack.

In some embodiments a platen is located between the moving ram plate and the stack, and the method further includes controlling heat transmission to the stack using the platen. In some embodiments the platen has a curvature on the face adjacent to the stack, and applying force via the moving ram plate deflects the curvature of the platen. In some embodiments the platen has a stiff enclosure made from a first material and an interior made from a second, different material.

In some embodiments the method further includes providing a bellows or flexible vacuum chamber isolating the stack from an external environment.

In some embodiments the method further includes providing at least one sensor, the at least one sensor configured to measure at least one of displacement, force, temperature or pressure; providing at least one controller, the controller configured to receive measurements from the at least one sensor; and issuing at least one command using the at least one controller, the at least one command affecting at least one of displacement, force, temperature or pressure.

In some embodiments the method includes altering a composition of an atmosphere surrounding the stack, a pressure of the atmosphere, or both.

In some embodiments the method further includes providing radiative shielding in proximity to the stack.

In another aspect, embodiments relate to a bonding apparatus for manufacturing large-scale metal laminated object parts. The apparatus includes a platen configured to receive a stack of metal sheets, each metal sheet having a thickness between 100 μm and 10 cm and an object portion and a support portion; and a moving ram plate driven by at least one ram and configured to apply force to the stack to bond the object portions of the stack, wherein the bonded object portions of the stack form an object having external dimensions exceeding 0.5 m in length, 0.5 m in width, and 0.1 m in height.

In some embodiments the moving ram plate comprises multiple segments, each adjacent pair of segments connected by a flexure, with each segment attached to a separate ram.

In some embodiments the apparatus further includes side plates configured to support the stack.

In some embodiments the apparatus further includes a platen between the moving ram plate and the stack, the platen configured to control heat transmission to the stack. In some embodiments the platen has a curvature on the face adjacent to the stack, and applying force via the moving ram plate deflects the curvature of the platen. In some embodiments the platen has a stiff enclosure made from a first material and an interior made from a second, different material.

In some embodiments the apparatus further includes a bellows or flexible vacuum chamber isolating the stack from an external environment.

In some embodiments the apparatus further includes at least one sensor configured to measure at least one of displacement, force, temperature or pressure; and at least one controller, the controller configured to receive measurements from the at least one sensor and issue at least one command affecting at least one of displacement, force, temperature or pressure.

In some embodiments the apparatus further includes means for altering the composition of an atmosphere surrounding the stack, a pressure of the atmosphere, or both.

In some embodiments the apparatus further includes radiative shielding in proximity to the stack.

In still another aspect, embodiments relate to a system for manufacturing large-scale metal laminated object parts. The system includes a stack assembly machine configured to receive a plurality of metal sheets, each metal sheet having a thickness between 100 μm and 10 cm; separate each metal sheet into an object portion and a support portion; and assemble the plurality of metal sheets into a stack. The system further includes the bonding machine described herein, configured to receive the stack from the stack assembly machine.

In some embodiments each metal sheet is separated into an object portion and a support portion by cutting through the metal sheet.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified:

FIG. 1 depicts an embodiment having multiple cylinders applying stress to a workpiece;

FIG. 2 depicts another embodiment having multiple cylinders applying stress to a workpiece;

FIG. 3 depicts yet another embodiment of a multiple cylinder bonding machine;

FIG. 4 depicts a disposable chamber placed around a workpiece;

FIG. 5 depicts an embodiment of a platen applying uniform stress and providing even heat transfer to a workpiece;

FIG. 6 depicts the platen of FIG. 5 applying uniform stress to a workpiece with deflection;

FIG. 7 is a flowchart of a control scheme for a multi-cylinder bonding machine;

FIG. 8 depicts a sheet pattern that is a part of a large part build;

FIG. 9 depicts the outer surface of a workpiece in contact with a heating platen;

FIG. 10 presents an embodiment utilizing active heat shielding; and

FIG. 11 depicts an embodiment of active heat shielding in more detail.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

### Definitions

Unless otherwise specified, the following terms as used herein shall have the meanings as provided below:

The term “workpiece” refers to a stack of sheets to be bonded into at least one part and at least one corresponding support structure.

The term “cylinder” refers to an electrically or fluidically driven telescoping tube which applies force to the workpiece.

The term “ram” refers to the mobile portion of the cylinder which applies force to the workpiece.

The term “moving ram plate” refers to a stiff plate of metal which at least one ram contacts and presses.

The term “bridge plate”refers to a stationary plate where cylinders are mounted.

The term “bolster” refers to a force-transmitting element that connects a moving ram plate to either a second moving ram plate or a platen.

The term “heat break” refers to a hollow portion of a ram or bolster where vacuum may be drawn to serve as radiative insulation.

The term “platen” refers to a metal plate which is configured to contact at least one surface of the workpiece. The platen may contain at least one of heating elements, cooling elements, and gas plumbing lines.

The term “platen interior” refers to a soft secondary material in a composite platen which transmits force and heat throughout the platen.

The term “sheet” refers generally to a metallic layer between 25 μm to 10 cm in thickness.

### EMBODIMENTS

Embodiments of the invention include methods and apparatus for the manufacture of large-scale laminated metal parts (i.e., having external dimensions exceeding 0.3-0.5 m in length, 0.3-0.5 m in width, and 0.1-0.5 m in height). Embodiments may include methods and apparatuses for the manufacture of large-scale laminated metal parts with print beds exceeding 1 m in length, 1 m in width, and exceeding 0.5 m in height, and thus exceeding a build volume of 0.5 m³.

Some embodiments include methods to apply force evenly to a workpiece via multiple rams and stiffened platens comprised of multiple alloys. Some embodiments include modifications to the workpiece itself, including designs for a temporary vacuum or controlled gas chamber constructed around the workpiece which obviate the need for high-rated vacuum chambers. Some embodiments include modifications to the workpiece and the support structures surrounding the part which direct force during bonding to the part. Some embodiments involve applying inert gasses and getters to purge trace oxidants from the workpiece. Control systems may be employed to coordinate the operation of the cylinders with heating, cooling, and pumping operations. Finally, some embodiments include alternative heating systems such as induction or joule heating which improve thermal uniformity across the workpiece during the bonding process. Examples of how these methods and apparatus may be implemented are discussed in more detail below.

### Multiple Cylinder Configurations

In some embodiments, a workpiece is compressed using an arrangement of moving ram plates, platens, cylinders, and rams. These components may have various configurations in accord with the scope of the present invention, some of which as discussed below.

In some embodiments, a moving ram plate is attached to at least one ram of at least one cylinder. The moving ram plate is made from a stiff material and serves as the force-transmitting element, which applies force on at least one of the platen and workpiece. The moving ram plate may be a single plate connected to multiple rams. Alternately, the moving ram plate may consist of multiple segments connected by flexible sections or flexures, with each segment attached to a separate ram head.

In some embodiments, a platen is configured to be compressed by a moving ram plate against the workpiece. The platen consists of a high thermal conductivity material that transfers heat to the workpiece. The platen may contain heating and cooling elements for controlling heat transmission to the workpiece. In some embodiments, the heat-transmitting element of the platen is comprised of at least one of aluminum or an aluminum alloy, copper or a copper alloy, molybdenum or a molybdenum alloy, tungsten or tungsten alloy, graphite, and a steel.

In some embodiments, the face of the mobile platen adjacent to the workpiece is flat. In some embodiments, the mobile platen has a curvature on the face adjacent to the workpiece, and that curvature is configured to deflect under load.

In some embodiments, the moving ram plate is adjacent to or integrated with the platen. In some embodiments, a force-transmitting bolster is placed between the moving ram plate and platen. The force-transmitting bolster transmits force from the moving ram plate to the platen. In some embodiments, additional bolsters may be used to connect the moving ram plate to the platen through the shielding of the bonding machine. In some embodiments, the force-transmitting bolster may contain a heat break to insulate the hydraulics from the higher temperatures of the bonding machine.

In some embodiments, multiple cylinders and rams are used to apply force across a moving ram plate. Multiple cylinders and rams may be used in parallel on a single face of the workpiece. The cylinders may be powered by hydraulics, air-driven hydraulics, pneumatics, or electrical means. In embodiments using electrical motors, the electrical motors may drive a non-backdrivable mechanism such as a lead screw.

In some embodiments, side plates are applied to the workpiece. The side plates resist deformation as force is applied to the workpiece. In some embodiments, side plates may be attached to moving ram plates.

In some embodiments, a moving ram plate is connected to at least two cylinders, which are configured to apply force in parallel to the moving ram plate. The moving ram plate is adjacent to the platen which transmits the force to the workpiece. The cylinders may be aligned via a bridge plate. The cylinders may be connected to independent sources of power with a control system to coordinate the operation. In some embodiments, the rams have heat breaks installed which insulate the cylinders and bridge plate from the heated moving ram plate, platen, and interior working volume of the bonding machine.

In some embodiments, the moving ram plate is comprised of a metal that does not diffuse easily into the platen. In other embodiments, a diffusion barrier is placed between the moving ram plate and the platen which does not diffuse easily into the moving ram plate and platen.

In some embodiments, at least one force-transmitting bolster is inserted between a moving ram plate and a platen. The force-transmitting bolsters may serve as a heat break between the moving ram plate and platen, and include hollow supports which could penetrate through shielding and insulation in the bonding machine. The heat break may be placed under vacuum or filled with an insulating gas.

In some embodiments, the rams and moving ram plate may be insulated via shielding from the mobile platen and the interior working volume of the bonding machine. The penetrations through the shielding and insulation may be connected to metal bellows or another flexible component to maintain atmospheric control in the bonding machine while allowing the mobile components to move. The hydraulic cylinders and moving ram plate are kept close to ambient temperature while the bonding machine can be ramped up to bonding temperature. The bridge plate may be held below the bonding temperature and is insulated via heat breaks in at least one of the rams or bolsters.

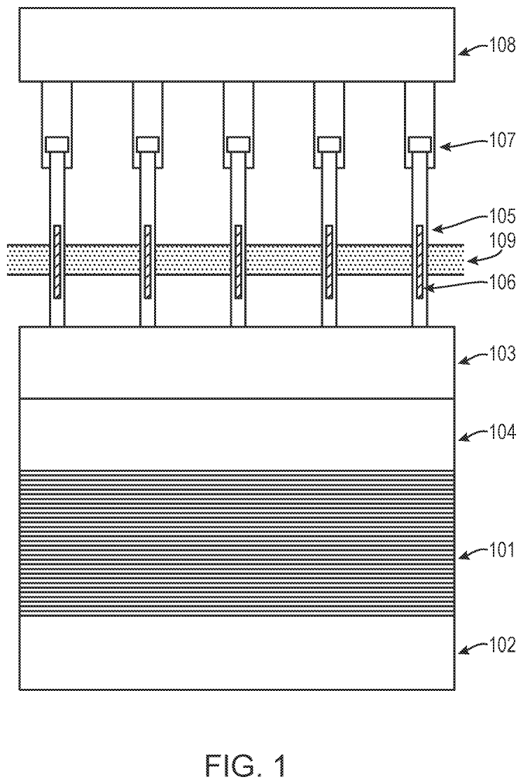

FIG. 1 depicts one embodiment of multiple cylinders applying stress to a workpiece. The workpiece (101) rests on a stationary heating platen (102). A moving ram plate (103) and mobile heating platen (104) are on the opposite face of the workpiece (101) from the stationary heating platen (102). Multiple rams (105) are connected to the moving ram plate (103). Each of the rams (105) has a heat break (106), which as shown consists of a vacuum-filled void space, to insulate the volume enclosed by the shielding. The cylinders (107) driving each ram (105) are connected to a bridge plate (108), which serves as a source of locomotion to the cylinders (107) and ultimately the rams (105). The rams (105) penetrate through a layer of insulating shielding (109) which also insulates the workpiece (101).

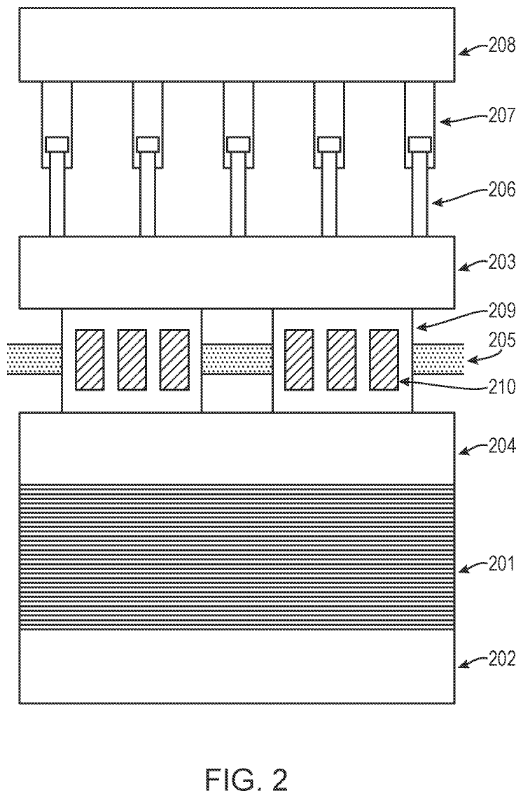

FIG. 2 depicts a second embodiment of multiple cylinders applying stress to a workpiece. The workpiece (201) rests on a stationary heating platen (202). A moving ram plate (203) and mobile heating platen (204) are configured to apply stress to the workpiece (201) through the insulative shielding (205). The rams (206), cylinders (207), and bridge plate (208) are exterior to the insulative shielding (205). At least one force-transmitting bolster (209) is connected to the moving ram plate (203) and mobile heating platen (204) through the insulative shielding (205). Heat breaks (210) may be installed in the force-transmitting bolster (209) to reduce heat transfer to the hydraulics.

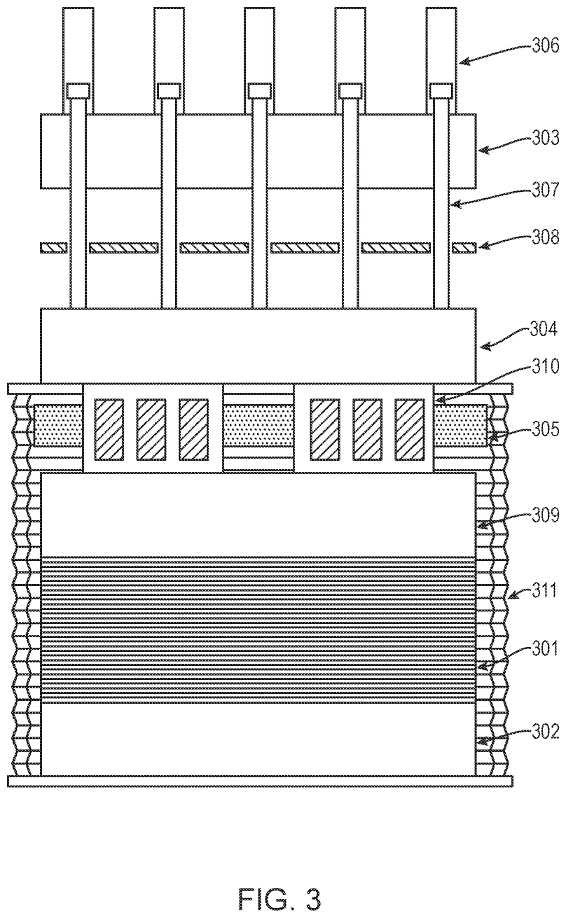

FIG. 3 depicts a third embodiment of a multiple cylinder bonding machine. The workpiece (301) rests on a stationary platen (302). A bridge plate (303) is configured in parallel with the moving ram plate (304). Both are outside of the shielding (305). The cylinders (306) and rams (307) are configured perpendicular to the bridge plate (303) and moving ram plate (304), with the position of each ram (307) measured against a reference plate (308). The mobile heated platen (309) is connected to the moving ram plate (304) through at least one force-transmitting bolster (310). A metal bellows (311) encompasses at least a portion of the cylinders (306) and rams (307) to enable atmospheric control around the workpiece (301).

### Controlled Environment

In some embodiments, the workpiece is sealed by a flexible portion which separates the volume of the workpiece from the volume of the bonding machine. The flexible portion may cover an arbitrary number of surfaces around the workpiece so long as it can be sealed to create a temporary workpiece enclosure. In some embodiments, the flexible portion may consist of the entire workpiece perimeter except for the platens, which it seals against. In some embodiments, the flexible portion may seal against the moving ram plate and enclose some portion of shielding. In some embodiments, the flexible portion may seal against the shielding or other insulation around the workpiece.

In some embodiments, the flexible portion may comprise a metal bellows. In some embodiments, the flexible portion may comprise a sheet of metal which does not bond to the workpiece. In some embodiments, this flexible portion may be disposable or otherwise be a limited use, replaceable component.

In some embodiments, the workpiece is enclosed by at least a metal sheet and at least one platen, and sealed on at least one side. This process may happen under a vacuum, a controlled gas atmosphere, or a combination of the two. This process may occur prior to the workpiece entering the bonding machine, or in a chamber of the bonding machine. At least one end of the foil may be sealed with at least one of a knife-edge seal, a tortuous path seal, a crimp seal, diffusion bonding, transient liquid phase bonding, and welding.

In some embodiments, a knife-edge seal against a metal gasket may be employed to form a high-vacuum seal. This may be employed in combination with the flexible or mobile portion of the housing described above.

In some embodiments, a tortuous path seal with a length of foil or another flexible component may be employed to form a vacuum seal. The foil may be folded or rolled to form a seal. In some embodiments, this tortuous path seal may be compressed to form a crimp seal.

In some embodiments, the flexible portion may be welded together to form a seal. In some embodiments, the weld may be between the flexible portion and at least one of the moving ram plate, bolster, shielding, and platen to form a workpiece enclosure.

In some embodiments, at least one port may be configured to pierce the workpiece enclosure and interface with the workpiece. There may be an alignment or registration feature present to align the port with the sealed workpiece.

In these embodiments, the workpiece enclosure partitions the enclosed volume from the remaining volume of the bonding machine, and enables independent atmospheric control around the workpiece.

In some embodiments, ports and gas plumbing lines may be used to connect the workpiece enclosure volume to at least one of the shielded internal volume, the remainder volume, external gas sources, and pumps. External gas sources may comprise at least one of non-oxidizing inert gasses such as nitrogen or a noble gas such as argon, and may comprise at least one of a reducing gas such as hydrogen. Ports and gas plumbing lines connect at least one of a high vacuum pump and a rough vacuum pump.

In some embodiments, getter materials that are designed to have a strong affinity for oxygen may be used to preferentially bind oxygen present in the atmosphere or in surface oxides of the workpiece. These getters may be located in the bonding machine, at least in the gas plumbing inlets to the bonding machine, the workpiece, within the shielded volume, and within the workpiece enclosure.

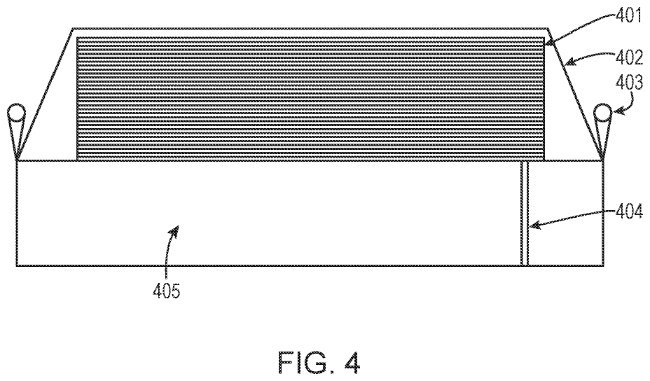

FIG. 4 depicts a disposable chamber placed around a workpiece (401). The workpiece (401) is placed beneath a flexible foil (402) which is sealed against a platen (405) via a knife-edge seal (403). At least one port (404) is able to access the internal volume of the disposable chamber and workpiece (401).

### Heterogenous Platens

In some embodiments, the platen is a composite formed from a stiff enclosure of one alloy with the interior filled with a metal of a second alloy organized in one or more cavities. During the bonding process, the interior material conducts heat throughout the platen and evenly to the part.

In some embodiments, the interior material in the composite platen is nearly liquid or very soft at the bonding process temperature. As the platen is compressed on the workpiece, the platen interior distributes the force applied uniformly across the face of the workpiece in contact with the platen.

In some embodiments, the platen enclosure is a material that does not interdiffuse with the platen interior. In some embodiments, a diffusion barrier is deposited between the platen enclosure and the platen interior which does not diffuse easily into the platen enclosure and platen interior.

In some embodiments, the interior metal in the composite platen is designed to melt at process temperature such that the phase change of the interior metal can add an additional method of control to prevent or reduce thermal overshoot or windup.

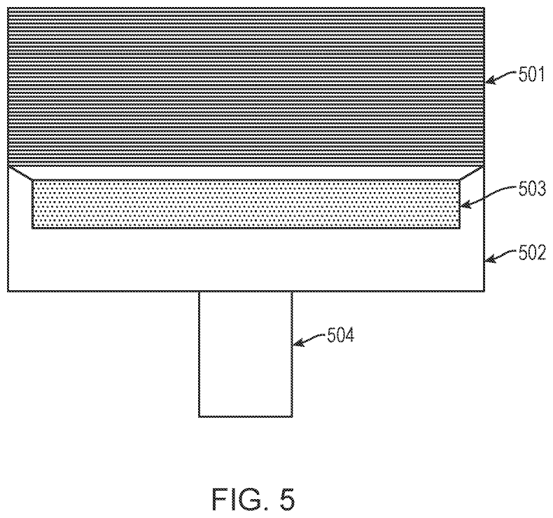

FIG. 5 depicts an embodiment of a platen applying uniform stress and providing even heat transfer to a workpiece. The workpiece (501) is compressed on at least one side by the heating platen (502). The heating platen (502) encloses a second material (503) which is soft at the bonding temperature, and which may have greater thermal conductivity than the heating platen shell (502). Additional support columns may be installed through the secondary material to increase mechanical strength (not shown). The ram (504) is depicted.

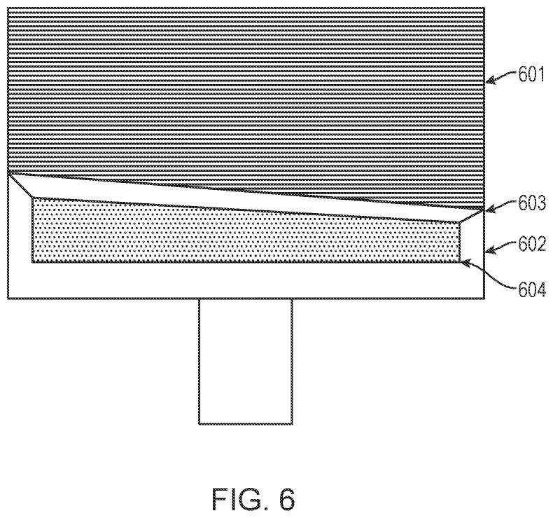

FIG. 6 depicts the platen (502) of FIG. 5 applying uniform stress to a workpiece with deflection. The surface of the workpiece (601) is in contact with the heated platen (602) at a non-90° angle relative to the ram. Flexures (603) allow the contacting surface of the platen (602) to conform to the surface of the workpiece (601), with the soft secondary material (604) flowing to equalize applied stress to the workpiece (601).

### Control Systems

In some embodiments, control systems may be installed to coordinate the operation of the bonding machine. Control systems may take inputs from installed displacement, force, temperature, and pressure sensors. Outputs of the control system may include displacement setpoints; settings for the cylinders to accomplish the displacement setpoints; a map of forces to apply to the workpiece; settings for individual cylinders to accomplish the force map; temperature setpoints; settings for the heating and cooling elements to accomplish the temperature setpoints; atmospheric control setpoints; and valve and pump settings to accomplish the atmospheric control setpoints.

In some embodiments, sensors may be used to feed information to the control system. Sensors may include displacement sensors to measure the deflection or displacement of the moving ram plate. Displacement sensors may be installed on each cylinder or ram to determine the exact position of each ram and determine the deflection of the moving ram plate. Examples of displacement sensors may include laser range finders. Sensors may include pressure gauges on cylinders, used to adjust the quantity of hydraulic working fluid applied to each cylinder. Displacements for individual cylinders or ram may be measured against a stationary reference plate that is not under load.

In some embodiments with a segmented moving ram plate, displacement sensors may be used to measure the deflection on each segment of the moving ram plate. The individual displacements and deflection measured may be used to adjust the force applied by individual rams.

In some embodiments, various force detectors including force transducers and other force-measuring devices are employed to measure the force applied by individual cylinders on the moving ram plate. Force transducers may be installed in multiple locations, either between the moving ram plate and workpiece, or between pistons and the rams (if the latter, need to account for friction between ram and bearings).

In some embodiments, control systems may be used to adjust the settings on individual cylinders so that each ram applies a specific force to the workpiece. An algorithm may be employed to calculate a map of required forces to apply specific stresses to the workpiece. In some embodiments, the applied stress may be uniform across the workpiece. In other embodiments, a stress profile may be applied across the workpiece with different regions selected for greater or less force to be applied. In some embodiments, the control system may apply a force setpoint to each region of the workpiece proportional to the effective force-transmitting area affected by each cylinder. In some embodiments, the force applied by each cylinder may be set independently of neighboring cylinders.

In some embodiments, temperature measuring devices such as thermocouples, optical barometers, RTDs, and others may be used to determine the temperature of the workpiece and of internal components in the bonding machine in one or more locations, such as but not limited to the platens and the shielding.

In some embodiments, various pressure detectors including at least one of capacitance manometers, ion gauges, Pirani gauges, and spinning rotor gauges may be installed to monitor the atmospheric pressure within any defined volume in the bonding machine, such as the workpiece enclosure volume, the shielded volume, and the remainder volume.

In some embodiments, the control system may apply a multi-step heating profile to the workpiece. In some embodiments, separate heating zones may be specified for different areas of the platen. The output of the control system may include heater settings to reach a particular temperature set point in the workpiece.

In some embodiments, the atmosphere surrounding the workpiece during the bonding process may be under an inert gas or under vacuum. The output of the control system may include particular valve settings and pump settings designed to maintain a particular atmospheric composition and pressure setpoint.

In some embodiments, this control system could use a linear PID controller, anti-windup algorithms, model-based control, or other nonlinear control schemes.

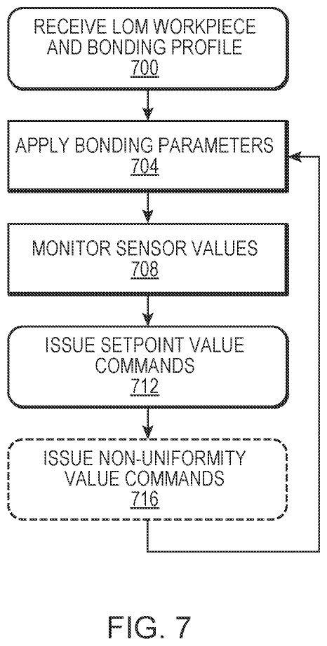

FIG. 7 depicts a control scheme flowchart for a multi-cylinder bonding machine. The control system receives a LOM workpiece and a bonding profile which corresponds to some part specification(s) (Step 700). The bonding profile may include applying a time-dependent temperature and stress profile to the workpiece under particular atmospheric conditions. In the course of creating the part using the specification(s), the control system applies the bonding profile to the workpiece by adjusting bonding parameters (Step 704). The control system subsequently monitors various sensor values (Step 708), including but not limited to temperature data from the heating platen, pressure data on the internal volume of the bonding machine, and position or force data for each cylinder or ram. When the control system identifies a sensor input that requires correction, it issues one or more commands (Steps 712, 716) that are appropriate to the sensor input at issue, such as setpoints for heating the platen, a cylinder or ram displacement map, and valve and pump settings to control the internal atmosphere of the bonding machine. The control system may separately monitor for deviations from the setpoints given in the bond profile and non-uniformities across the workpiece. Separate but interrelated control loops may be implemented to simultaneously track the average of the sensor readings and adjust for any deviations from the setpoint value (Step 712) and adjust for observed non-uniformities over the workpiece (Step 716).

### Workpiece Modifications

In embodiments of this invention, a workpiece is assembled from a series of sheets that have been patterned and stacked. In some embodiments, the thickness of each sheet may vary between 25 μm to 1 cm. In some embodiments, the minimum sheet thickness may be 100 μm. In some embodiments, the maximum sheet thickness may be 10 cm. The thickness of each sheet is selected as a function of the resolution required to generate the surface features on the part within desired tolerances. Workpieces may contain sheets of more than one thickness.

In some embodiments, channels and ports may be cut into the support structure of the workpiece to allow gasses to flow through and be removed from the workpiece.

In some embodiments, the support structure is perforated or otherwise cut so that it does not transmit force when force is applied to the support structure during the bonding process. The removal of a portion of the support structure region of a sheet layer may reduce the stiffness of the sheet layer around the cut or direct the applied force towards or away from the part for bonding. In some embodiments, this may involve removing a portion of the support structure not directly above or below the part to reduce the total area to be bonded, which may reduce the overall force required for bonding the workpiece. In some embodiments, the support structure may not be bonded or only be weakly bonded during the bonding process.

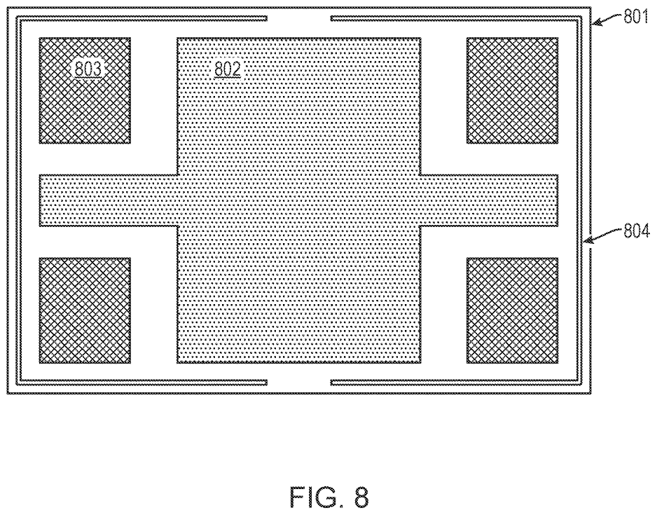

FIG. 8 depicts a sheet pattern that is a part of a large part build. The sheet (801) is patterned with a part region (802). The remaining support structure has multiple cut regions (803) to reduce the support structure. Optionally, a collar channel (804) is patterned on the sheet to be filled with an inert gas during bonding.

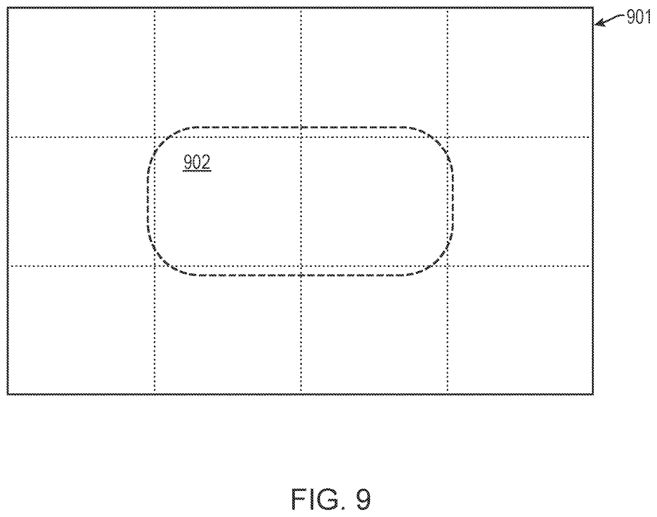

FIG. 9 depicts the outer surface of a workpiece in contact with a heating platen. The top of the workpiece is partitioned into several separate regions (901), each corresponding to a force zone on the workpiece surface affected by an individual ram. The workpiece is further partitioned into at least two heating zones by the line (902), which roughly correspond to the map of ram regions.

### Ram Alternatives

Although the preceding section refers specifically to use of rams to apply force to a workpiece, any mechanism for applying high force with a relatively short stroke would be suitable for use in various embodiments.

One such option involves the use of thermal expansion, which could be implemented by heating the platen and/or the attached column. The outer edges of the columns could be cooled and insulated such that the temperature of the thermal expansion could be maintained at a relatively uniform, known temperature. Another option involves the use of shape memory material, using the process heat to actuate a shape memory structure which generates displacement force. Still another option involves the use of a piezo-electric actuator.

### Heat Transfer

Conductive heat transfer may be too slow and non-uniform for certain large parts, therefore certain embodiments apply heat to workpieces via a combination of conduction and radiative heating instead of conduction alone.

Some embodiments apply heat to at least one face of a workpiece using conduction while using radiative heating to apply heat to the middle of the workpiece during the initial temperature ramp. The dominant role of thermal conduction has the benefit of better control of the final process temperature, and the use of radiative heating can decrease cycle time, increase the thermal uniformity of the build, and enable more accurate process windows during processing.

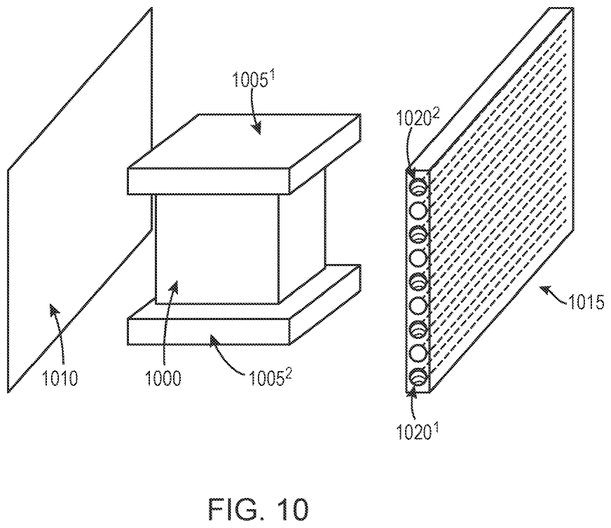

Some embodiments utilize active shielding to actively heat or cool the workpiece at the various stages of the bonding process in combination with radiative heating. FIG. 10 shows one embodiment utilizing active shielding. As illustrated, the workpiece 1000 is placed between and subject to stress from platens 1005^{N}, turning the workpiece 1000 into a laminated object as discussed above. Passive shielding 1010 helps maintain the temperature of the workpiece 1000 as pressure is applied.

In some embodiments passive shielding 1010 has a reflective surface facing the workpiece 1000, reflecting heat emitted from heating elements in the fabrication chamber (such as active shielding) and helping to maintain the desired temperature of the chamber. In some embodiments the passive shielding 1010 includes one or more insulative layers (including vacuum layers) in order to maintain the desired temperature of the chamber.

As shown, the active shielding has a thicker plate 1015 with channels 1020^{N} running through it, with multiple thin vacuum-gapped layers (not shown) between the channels 1020^{N} and the external environment.

In some embodiments the active shielding is heated using heating rods placed within the channels, similar to the technique used for heating the platens. In some embodiments the active shielding is heated by pumping hot oils or gasses through the channels. In some embodiments, the side of the active shielding facing towards the workpiece is coated or textured to raise its emissivity and increase radiative heat transfer to the part. In some embodiments the side of the shielding facing away from the workpiece is coated, polished or surface-treated to lower its emissivity and its heat transfer to the walls of the apparatus, keeping heat on the workpiece. Surface treatments could be selected for thermal stability over the temperature range experienced in the bond machine and stability under vacuum. Examples of how stability may be measured include selecting materials that do not chemically degrade under the process conditions, that do not offgas chemical species including oxidants while under process conditions, and selecting materials which vaporize at higher temperatures or lower pressures than applied during the bonding process.

In the ramp up stage, radiative heat transfer from the active shielding is used to heat the sides of the workpiece 1000 to get it to bonding temperature more quickly. Radiative heat transfer from the active shielding also helps maintain workpiece temperature uniformity at bonding temperatures and has a faster reaction time than platens 1005^{N}, which have a high thermal mass.

In some embodiments, when bonding has reached a safe maximum temperature, the vacuum around the finished part can be diminished, admitting ambient air or an inert gas which allows for more convective and conductive heat transfer out of the workpiece.

In some embodiments the active shielding has a second set of channels that parallels the heating channels in the shielding and is used to cool the workpiece during the ramp down process. In other embodiments the same set of channels may be used for both heating and cooling when temperature changes are achieved by pumping hot oils or gasses through the channels.

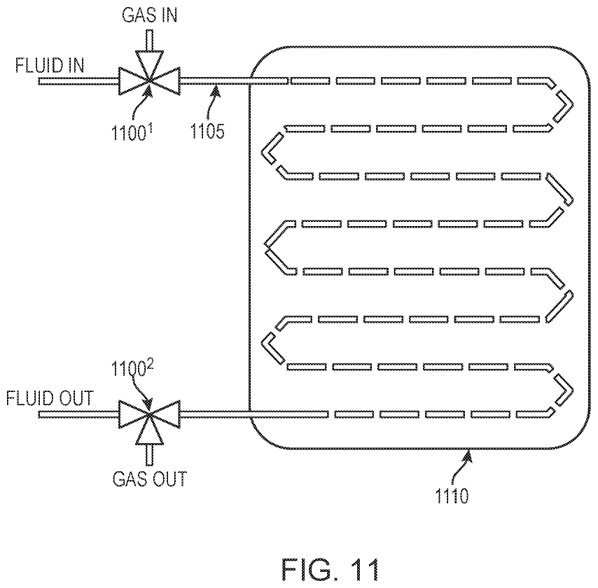

FIG. 11 shows an embodiment of active shielding with valving to permit the selective pumping of liquids and gasses through the same set of channels in the shielding. As illustrated, valves 1100^{N} permit the selective admission of a gas or liquid (in this case, water) to a channel 1105 winding through active shielding 1110.

During ramp down, the goal is to use radiative heat transfer to cool the sides of the workpiece to achieve homogenization more quickly. The process begins by pumping cool, dry air through the channel 1105 to decrease the temperature of the shielding 1110 and increase radiative heat transfer away from the workpiece. Once the shielding 1110 is sufficiently cooled, water or another coolant can be pumped through the channel 1105 to further cool the workpiece. Once the workpiece is sufficiently cooled, the channel 1105 may be purged using gas or an appropriate liquid.

### Push-Pull Piston Configurations

Certain embodiments utilize a set of slow-acting hydraulic pistons to apply heavy force to the workpiece, and a second set of fast-acting pneumatic pistons to act in opposition to the application of heavy force and provide fine control. The combination gives finer control over a wider range of applied forces (i.e., increases the turndown ratio), because pistons usually have a narrow operating range where they can accurately apply force, and at the extremes of their operating ranges control is less precise.

### Equivalents

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

1. A method for the manufacture of large-scale metal laminated object parts, the method comprising:
assembling a plurality of metal sheets in a stack, each metal sheet having:
a thickness between 100 μm and 10 cm; and
an object portion and a support portion; and
removing a support portion from the stack; and
applying force to the stack via a moving ram plate driven by at least one ram to bond the object portions of the stack, wherein the moving ram plate comprises multiple segments, each adjacent pair of segments connected by a flexure, with each segment attached to a separate ram, and
wherein the bonded object portions of the stack form an object having external dimensions exceeding 0.5 m in length, 0.5 m in width, and 0.1 m in height.

2-3. (canceled)

4. The method of claim 1 wherein a platen is located between the moving ram plate and the stack, and the method further comprises controlling heat transmission to the stack using the platen.

5. The method of claim 4 wherein the platen has a curvature on the face adjacent to the stack, and applying force via the moving ram plate deflects the curvature of the platen.

6. The method of claim 4 wherein the platen comprises a stiff enclosure made from a first material and an interior made from a second, different material.

7-10. (canceled)

11. A bonding apparatus for manufacturing large-scale metal laminated object parts, the bonding apparatus comprising:
a platen configured to receive a stack of metal sheets, each metal sheet having:
a thickness between 100 μm and 10 cm; and
an object portion and a support portion; and
a moving ram plate driven by at least one ram and configured to apply force to the stack to bond the object portions of the stack, wherein the moving ram plate comprises multiple segments, each adjacent pair of segments connected by a flexure, with each segment attached to a separate ram, and
wherein the bonded object portions of the stack form an object having external dimensions exceeding 0.5 m in length, 0.5 m in width, and 0.1 m in height.

12-13. (canceled)

14. The bonding apparatus of claim 11 further comprising a platen between the moving ram plate and the stack, the platen configured to control heat transmission to the stack.

15. The bonding apparatus of claim 14 wherein the platen has a curvature on the face adjacent to the stack, and applying force via the moving ram plate deflects the curvature of the platen.

16. The bonding apparatus of claim 14 wherein the platen comprises a stiff enclosure made from a first material and an interior made from a second, different material.

17. (canceled)

18. The bonding apparatus of claim 11 wherein the support portion of the stack is used as an in-situ vacuum or purged gas chamber.

19. The bonding apparatus of claim 18 wherein at least one edge of the support portion of the stack is sealed before or during the bonding process using transient liquid phase bonding, brazing, diffusion bonding, or welding.

20-22. (canceled)

23. A system for manufacturing large-scale metal laminated object parts, the system comprising:
a stack assembly machine configured to:
receive a plurality of metal sheets, each metal sheet having a thickness between 100 μm and 10 cm;
separate each metal sheet into an object portion and a support portion; and
assemble the plurality of metal sheets into a stack; and
the bonding apparatus of claim 11, configured to receive the stack from the stack assembly machine.

24. The system of claim 23 wherein each metal sheet is separated into an object portion and a support portion by cutting through the metal sheet.
